(19) United States
(12) Patent Application Publication
(10) Pub. No.: US 2026/0214542 A1
(43) Pub. Date: Jul. 23, 2026

(54) SOFTWARE-DEFINED NETWORKING (SDN)-BASED MULTIPLE RADIO ACCESS TECHNOLOGY (MULTI-RAT) HANDOVER

(71) Applicant: University of Florida Research Foundation, Incorporated, Gainesville, FL (US)

(72) Inventors: Janise McNair, Gainesville, FL (US); Pavan Mangipudi, Gainesville, FL (US); Venkata Vamsi Krishna Potla, Gainesville, FL (US)

(21) Appl. No.: 19/454,007

(22) Filed: Jan. 20, 2026

Related U.S. Application Data
(60) Provisional application No. 63/748,182, filed on Jan. 22, 2025.

(51) Int. Cl. H04W 36/30; H04L 45/745

(52) U.S. Cl. CPC H04W 36/304; H04L 45/745

(57) ABSTRACT

A method for processing a packet-in message comprising receiving the packet-in message from a connected node, wherein the packet-in message comprises a modified payload with data corresponding to one or more received signal strength indicator (RSSI) levels and one or more media access control (MAC) addresses corresponding to one or more nodes that are within range of a user equipment (UE); determining an optimal node based on the one or more RSSI levels, wherein the optimal node comprises a highest RSSI level relative to the one or more RSSI levels; and in response to determining that the optimal node is different from the connected node, performing, by the one or more processors, handover processing comprising configuring a flow rule on the optimal node.

### CROSS REFERENCE TO RELATED APPLICATION

This application claims the priority of U.S. Provisional Application No. 63/748,182, entitled “SOFTWARE-DEFINED NETWORKING (SDN)-BASED MULTIPLE RADIO ACCESS TECHNOLOGY (MULTI-RAT) HANDOVER,” filed on January 22, 2025, the disclosure of which is hereby incorporated by reference in its entirety.

### GOVERNMENT SUPPORT

This invention was made with government support under Grant No. 2030122, awarded by the National Science Foundation. The government has certain rights in the invention.

### BACKGROUND

With each new generation of cellular communication technology, the number of deployed networks and base stations across a geographical area has exponentially increased to meet the demands of increasing number of users. As a result, the dense deployment of cellular networks has led to the coexistence of various wireless radio access technologies (RATs), paving the way for multi-RAT networks. Multi-RAT networks have the potential to address the cellular industry’s growing demands for capacity and connectivity by leveraging coexisting RATs to enhance overall connectivity. Software defined networking (SDN) has been used to achieve multi-RAT networks by integrating an SDN controller to interface between the various RATs. However, integration alone does not provide seamless connectivity. Handover, in general, may facilitate the movement of users between neighboring cells of a network, without a drop in network connectivity. However, existing handover protocols operate at the physical layer (PHY) of the OSI protocol suite and are based on a single type of RAT. Existing technology in the domain of multi-RAT networks do not cover the aspect of handover in such networks.

### BRIEF SUMMARY

Various embodiments described herein relate to methods, apparatus, systems, computing devices, computing entities, and/or the like for facilitating seamless handover in software-defined networking (SDN)-based multiple radio access technology (multi-RAT) networks, through the implementation of seamless handovers performed at an SDN controller.

According to some embodiments, a method comprises receiving a packet-in message from a connected node, wherein the packet-in message comprises a modified payload with data corresponding to one or more received signal strength indicator (RSSI) levels and one or more media access control (MAC) addresses corresponding to one or more nodes that are within range of a user equipment (UE); determining an optimal node based on the one or more RSSI levels, wherein the optimal node comprises a highest RSSI level relative to the one or more RSSI levels; and in response to determining that the optimal node is different from the connected node, performing handover processing comprising configuring a flow rule on the optimal node.

In some embodiments, the UE periodically scans for the one or more nodes and appends the one or more RSSI levels to a payload of a packet corresponding to the packet-in message. In some embodiments, the method further comprises updating a MAC address-to-port lookup table based on a source MAC address and an input port address from the packet-in message; searching the packet-in message for the modified payload; and determining the modified payload is present in the packet-in message. In some embodiments, the method further comprises, in response to determining that the optimal node comprises the connected node, and in response to determining that a destination MAC address is known, assigning an output port based on the MAC address-to-port lookup table; and generating a match object based on a source Internet Protocol (IP) address and a destination IP address to generate the flow rule that forwards one or more packets to the output port. In some embodiments, the method further comprises, in response to determining that the destination MAC address is unknown, configuring the output port to a flooding action. In some embodiments, performing the handover processing further comprises configuring one or more output ports to a flooding action that corresponds to forwarding the packet-in message to the one or more nodes until a path setup; generating a match object based on a source Internet Protocol (IP) address and a destination IP address; generating, based on the match object, the flow rule that initiates the flooding action; and configuring the flow rule on the optimal node, the connected node, and one or more intermediate nodes. In some embodiments, the method further comprises determining whether the connected node is in range of the UE; and in response to determining that the connected node is not in range of the UE, performing fallback processing comprising configuring an output port to a flooding action that corresponds to broadcasting a packet corresponding to the packet-in message; generating a match object based on a source Internet Protocol (IP) address and a destination IP address; and configuring the flow rule based on the match object and one or more actions on a switch that the packet-in message was received from. In some embodiments, the flow rule comprises a hard time-out.

According to some embodiments, a system comprises one or more processors and one or more non-transitory computer readable media storing processor-executable instructions that, when executed by the one or more processors, cause the one or more processors to perform operations comprising receiving a packet-in message from a connected node, wherein the packet-in message comprises a modified payload with data corresponding to one or more received signal strength indicator (RSSI) levels and one or more media access control (MAC) addresses corresponding to one or more nodes that are within range of a user equipment (UE); determining an optimal node based on the one or more RSSI levels, wherein the optimal node comprises a highest RSSI level relative to the one or more RSSI levels; and in response to determining that the optimal node is different from the connected node, performing, by the one or more processors, handover processing comprising configuring a flow rule on the optimal node.

In some embodiments, the UE periodically scans for the one or more nodes and appends the one or more RSSI levels to a payload of a packet corresponding to the packet-in message. In some embodiments, the operations further comprise updating a MAC address-to-port lookup table based on a source MAC address and an input port address from the packet-in message; searching the packet-in message for the modified payload; and determining the modified payload is present in the packet-in message. In some embodiments, the operations further comprise, in response to determining that the optimal node comprises the connected node, and in response to determining that a destination MAC address is known, assigning an output port based on the MAC address-to-port lookup table; and generating a match object based on a source Internet Protocol (IP) address and a destination IP address to generate the flow rule that forwards one or more packets to the output port. In some embodiments, the operations further comprise, in response to determining that the destination MAC address is unknown, configuring the output port to a flooding action. In some embodiments, performing the handover processing further comprises configuring one or more output ports to a flooding action that corresponds to forwarding the packet-in message to the one or more nodes until a path setup; generating a match object based on a source Internet Protocol (IP) address and a destination IP address; generating, based on the match object, the flow rule that initiates the flooding action; and configuring the flow rule on the optimal node, the connected node, and one or more intermediate nodes. In some embodiments, the operations further comprise determining whether the connected node is in range of the UE; and in response to determining that the connected node is not in range of the UE, performing fallback processing comprising configuring an output port to a flooding action that corresponds to broadcasting a packet corresponding to the packet-in message; generating a match object based on a source Internet Protocol (IP) address and a destination IP address; and configuring the flow rule based on the match object and one or more actions on a switch that the packet-in message was received from. In some embodiments, the flow rule comprises a hard time-out.

According to some embodiments, one or more non-transitory computer-readable storage media storing instructions that, when executed by one or more processors, cause the one or more processors to perform operations comprising receiving a packet-in message from a connected node, wherein the packet-in message comprises a modified payload with data corresponding to one or more received signal strength indicator (RSSI) levels and one or more media access control (MAC) addresses corresponding to one or more nodes that are within range of a user equipment (UE); determining an optimal node based on the one or more RSSI levels, wherein the optimal node comprises a highest RSSI level relative to the one or more RSSI levels; and in response to determining that the optimal node is different from the connected node, performing, by the one or more processors, handover processing comprising configuring a flow rule on the optimal node.

In some embodiments, the UE periodically scans for the one or more nodes and appends the one or more RSSI levels to a payload of a packet corresponding to the packet-in message. In some embodiments, the operations further comprise updating a MAC address-to-port lookup table based on a source MAC address and an input port address from the packet-in message; searching the packet-in message for the modified payload; and determining the modified payload is present in the packet-in message. In some embodiments, the operations further comprise, in response to determining that the optimal node comprises the connected node, and in response to determining that a destination MAC address is known, assigning an output port based on the MAC address-to-port lookup table; and generating a match object based on a source Internet Protocol (IP) address and a destination IP address to generate the flow rule that forwards one or more packets to the output port.

### BRIEF DESCRIPTION OF THE DRAWINGS

Embodiments incorporating teachings of the present disclosure are shown and described with respect to the figures presented herein.

FIG. 1 depicts an example topology of an SDN-based multi-RAT network in accordance with some embodiments of the present disclosure.

FIG. 2 depicts an example architecture of an SDN-based multi-RAT network in accordance with some embodiments of the present disclosure.

FIG. 3 is an example TCP packet format in accordance with some embodiments of the present disclosure.

FIG. 4 depicts a flowchart of an example process for processing a packet-in message in accordance with some embodiments of the present disclosure.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### General Overview and Example Technical Improvements

As described above, there are many technical challenges and difficulties associated with using software-defined networking (SDN) for handovers in multiple radio access technology (multi-RAT) networks. Various example embodiments of the present disclosure overcome such technical challenges and difficulties and provide various technical advancements and improvements. In accordance with various embodiments of the present disclosure, an SDN-based multi-RAT handover solution is disclosed that utilizes real-time received signal strength indicator (RSSI) measurements from user equipment (UE) devices to facilitate handovers at an SDN controller, ensuring seamless movement of users across the multi-RAT network.

The present disclosure provides an SDN-based multi-RAT network handover, where an SDN controller may collect periodic measurements from UE devices about access points in range and implement a handover decision based on a centralized view the SDN controller has of a network. As such, the disclosed SDN-based multi-RAT handover provides seamless connectivity when UE devices move between different radio access technologies (RATs). Multi-RAT handovers may enable seamless transitions between different RATs, playing a crucial role in improving network availability. During periods of cellular network congestion, multi-RAT handovers may be used to offload traffic to non-cellular RATs, optimizing both capacity and user experience.

In some embodiments, to facilitate handover between multi-RAT nodes, the movement of a UE between them is detected and a corresponding flow rule is configured at a node the UE is moving to. In some embodiments, when a UE is connected to a node in the multi-RAT network, the UE periodically scans the available nodes in the UE’s coverage area. In some embodiments, the UE obtains RSSI levels with respect to each node available in the coverage area and appends the RSSI levels in the payload of the packets that are sent to the connected node.

In some embodiments, the connected node sends a packet-in message to an SDN controller in response to a programmed hard time-out. In some embodiments, the hard time-out causes removal of flow rules on the connected node after a specified amount of time. In some embodiments, due to the lack of flow rules for the connected node, a packet-in message event is triggered which causes forwarding, to the SDN controller, of a packet-in message received by the connected node from the UE. In some embodiments, the packet-in message comprises a modified payload with the media access control (MAC) addresses of all nodes in range and corresponding RSSI levels obtained by the UE. In some embodiments, the packet-in message allows the SDN controller to receive periodic updates of a UE’s position in a network and anticipate when a handover is triggered.

In some embodiments, an SDN-based multi-RAT handover comprises a controller-driven, RAT agnostic, RSSI-based handover mechanism for SDN-enabled multi-RAT networks. In some embodiments, an enhanced transmission control protocol (TCP) packet format is provided to transmit physical layer data associated with UEs and nodes to an SDN controller via a packet-in message, enabling the SDN controller to make informed handover decisions based on a comprehensive network perspective. In some embodiments, the SDN controller comprises a centralized decision making mechanism and is configured to utilize a global view of an SDN-based multi-RAT network to optimize handover decisions across the SDN-based multi-RAT network. In some embodiments, a periodic flow rule refresh is implemented to ensure up-to-date RSSI levels and network conditions, prompting fresh packet-in messages that are provided to an SDN controller. In some embodiments, on-demand RSSI-based flow rules are implemented at the network switch layer (e.g., OpenFlow) interfacing with various RATs, such as fifth generation (5G) base stations (gNBs) and WiFi access points (APs), to streamline packet transfer and buffering between the RATs.

### Example Technical Implementation of Various Embodiments

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable storage media (including volatile and non-volatile media).

A non-volatile computer-readable storage medium may include one or more magnetic and/or electro-mechanical storage devices, such as floppy disk(s), hard disk(s), magnetic tape, punch card(s), paper tape(s), optical mark sheet(s) (or any other physical medium with patterns of holes or other optically or mechanically detectable indicia), any other non-transitory magnetic medium, and/or the like. A non-volatile computer-readable storage medium may additionally or alternatively include one or more optical storage devices, such as compact disc read only memory (CD-ROM), compact disc-rewritable (CD-RW), any other non-transitory optical medium, and/or the like. A non-volatile computer-readable storage medium may additionally or alternatively include one or more read-only memory (ROM); programmable read-only memory (PROM); erasable programmable read-only memory (EPROM); electrically erasable programmable read-only memory (EEPROM), such as flash memory; and/or the like. In some examples, flash memory may comprise a set of field effect transistors and/or other devices or circuitry that implement serial and/or parallel NAND, NOR, and/or other hardware logic for storing data. In some examples, solid state storage (SSS), such as a solid state drive (SSD), flash drive, solid-state hybrid drives (SSHDs), and/or the like may include flash memory (SSHDs are a hybrid device that may include a hard disk and flash memory in some examples); and, in some examples, flash memory may be used as cache memory, implemented as a basic input output system (BIOS) chip or part of a BIOS chip, and/or the like. A non-volatile computer-readable storage medium may additionally or alternatively include 3D XPoint memory, non-volatile random access memory (NVRAM) (e.g., bridging random access memory (CBRAM), phase-change random access memory (PRAM), magnetoresistive random-access memory (MRAM), ferroelectric random-access memory (FeRAM)), racetrack memory, and/or the like. A non-volatile computer-readable storage medium may additionally or alternatively include one or more thermo-mechanical storage devices, such as Millipede memory; one or more molecular memory repositories; and/or the like.

A volatile computer-readable storage medium may include random access memory (RAM), dynamic random access memory (DRAM), static random access memory (SRAM), synchronous dynamic random access memory (SDRAM), cache memory (including various levels), register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### Example System Architecture

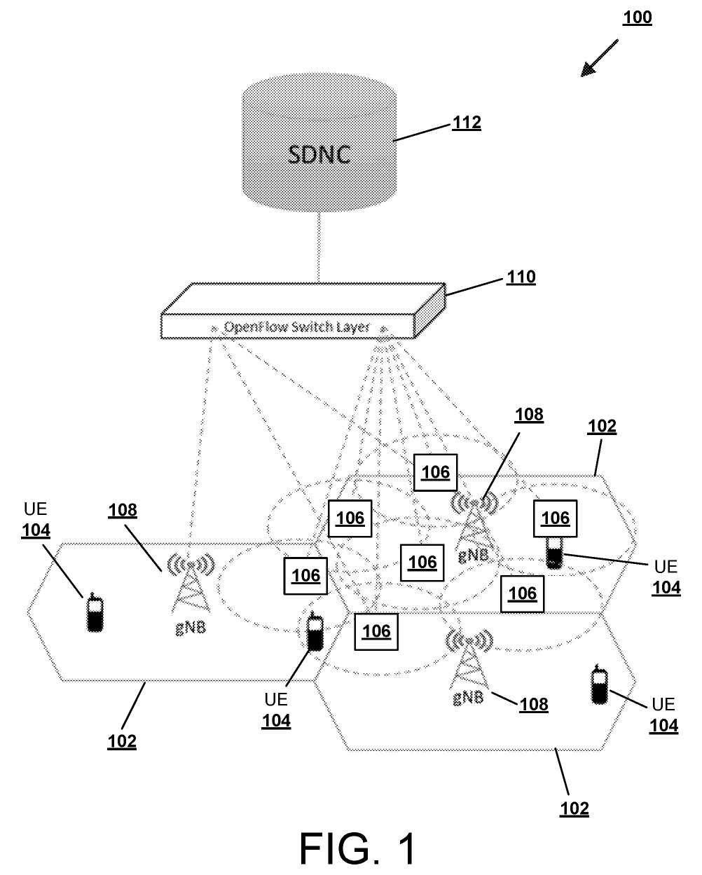

FIG. 1 depicts an example topology of an SDN-based multi-RAT network 100 in accordance with some embodiments of the present disclosure. The SDN-based multi-RAT network 100 comprises a plurality of cells 102. A plurality of UEs 104 within each cell are provided with network service (e.g., 5G and/or Wi-Fi service) by one or more nodes that comprise base stations, such as WiFi APs 106 and gNBs 108. A UE of the plurality of UEs 104 may move within a cell of the plurality of cells 102 in a seamless manner such that network service may be continuously provided to the UE by one or more of WiFi APs 106 or gNBs 108 within the cell uninterrupted. As the plurality of UEs 104 move between the plurality of cells 102, network service provided to the plurality of UEs 104 may also be transitioned between the plurality of cells 102 via handover, as disclosed in further detail herewith. In some embodiments, the one or more WiFi APs 106 and gNBs 108 may be interfaced with an OpenFlow switch layer 110 comprising OpenFlow (OF)-enabled switches (and/or the like) to provide SDN capabilities. The OpenFlow switches of the OpenFlow switch layer 110 are coupled to an SDN controller 112. The connection between the switches of the OpenFlow switch layer 110 and corresponding WiFi APs 106 or gNBs 108 may be at the level of the network layer and is subsequent to processing of packets from lower layers in accordance with RAT standards.

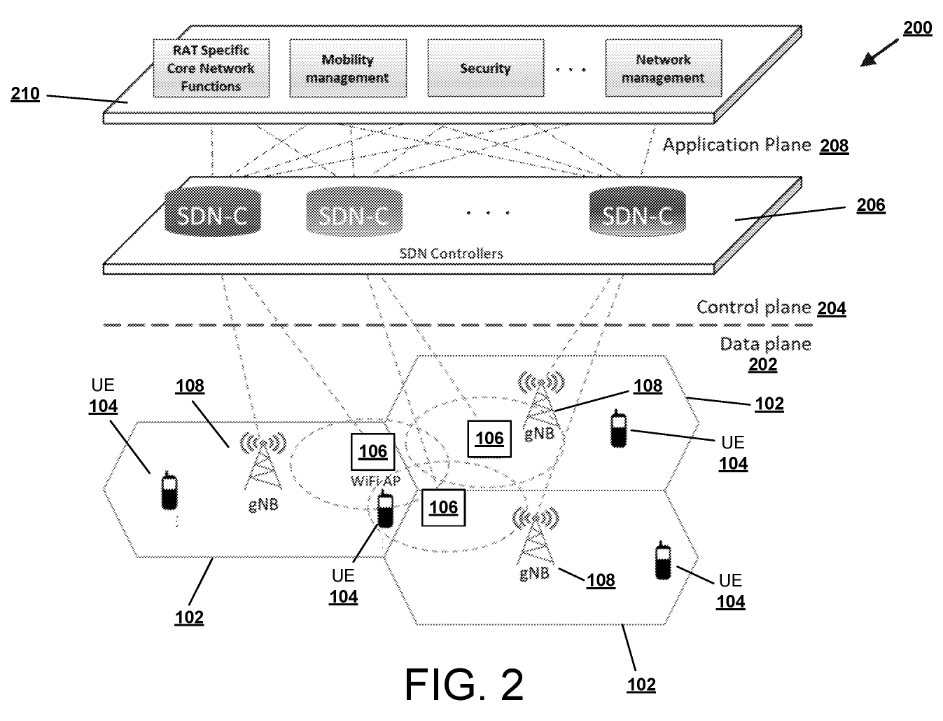

FIG. 2 depicts an example architecture of an SDN-based multi-RAT network 200 in accordance with some embodiments of the present disclosure. The SDN-based multi-RAT network 200 (e.g., SDN-based multi-RAT network 100) comprises a plurality of nodes (e.g., WiFi APs 106 and gNBs 108) that are based on various RATs. Integration of the various RATs may be facilitated through the use of SDN. The UEs 104, WiFi APs 106, and gNBs 108 may provide a data plane 202, a plurality of SDN controllers 206 may provide the control plane 204, and applications 210 running on the plurality of SDN controllers 206 may provide an application plane 208. Various types of applications, such as RAT-specific core network functions, mobility management, security, and network management, may run on the application plane 208 to optimize underlying operations of the data plane 202 through the plurality of SDN controllers 206.

In some embodiments, an SDN controller (e.g., of the plurality of SDN controllers 206) comprises one or more computing devices, servers, virtual machines, containers, and/or distributed systems that manages and controls network behavior by maintaining a global view of a network and providing instructions to network devices. An SDN controller may communicate with network devices through standardized protocols or application programming interfaces (APIs) to configure forwarding behavior, configure flow rules, and collect network state information. In some embodiments, an SDN controller executes one or more applications that implement network policies, perform traffic engineering, manage mobility, or provide other network services. An SDN controller may interface with switches, routers, WiFi APs 106, gNBs 108, or other network elements to separate the control plane 204 from the data plane 202, enabling programmable and dynamic network management.

The control plane 204 comprises the plurality of SDN controllers 206. Implementing the plurality of SDN controllers 206 may eliminate a single point of failure in the SDN-based multi-RAT network 200 while reducing control signal bottleneck that may arise from using a single SDN controller. The plurality of SDN controllers 206 may be helpful in interfacing with data plane switches in different geographical locations, thereby providing higher coverage. According to various embodiments of the present disclosure, the plurality of SDN controllers 206 may be configured to perform handover operations on the application layer.

The data plane 202 may comprise WiFi APs 106 and gNBs 108 that provide network service to cells 102, within which UEs 104 may move seamlessly. The WiFi APs 106 and gNBs 108 may be further connected to OpenFlow-enabled switches that are integrated with an SDN controller of the plurality of SDN controllers 206. In some embodiments, the connection between the OpenFlow-enabled switches and their respective nodes (e.g., WiFi APs 106 and/or gNBs 108) operates at the network layer (e.g., L3) such that the connection occurs after packets have been processed according to the respective RAT’s protocols at the lower layers.

### Example System Operations

Various embodiments of the present disclosure describe steps, operations, processes, methods, functions, and/or the like for facilitating SDN-based handover between nodes in a multi-RAT network. In some embodiments, a handover process is performed based on topological information and measurements that are transmitted from the physical layer to an SDN controller (e.g., of the plurality of SDN controllers 206). In some embodiments, the measurements comprise the RSSI of a UE (e.g., of the plurality of UEs 104) with respect to each node (e.g., WiFi APs 106 and/or gNBs 108) within its communication range. A handover process may be initiated when the RSSI value of a target node exceeds that of a current node to which a UE is connected. Thus, to facilitate handover between multi RAT nodes, the movement of UEs between the nodes may be detected and used to determine corresponding flow rules to configure at nodes the UEs are moving to.

In some embodiments, configuring flow rules may comprise a process by which an SDN controller configures one or more network devices, such as switches or nodes, with instructions that define how to handle packets matching specified criteria. A flow rule may comprise match fields that identify packets based on attributes, such as source or destination addresses, port numbers, protocol types, or other header information, and corresponding actions that specify how matching packets should be processed, such as forwarding to a particular port, dropping, modifying, or flooding. Configuration of flow rules may be performed by transmitting configuration messages from an SDN controller to a node, causing the node to store the flow rule in a flow table. In some embodiments, flow rules may be installed proactively before packets arrive or reactively in response to packet-in messages. Flow rules may comprise timeout parameters, such as hard time-outs or idle time-outs, that cause automatic removal of the flow rule after a specified period of time or inactivity.

In some embodiments, when a UE is connected to a node, the UE periodically scans for available nodes and obtains the RSSI levels with respect to each node available in its coverage area. In some embodiments, the UE collects the media access control (MAC) address and RSSI for each node in its vicinity and appends the RSSI levels along with the respectively corresponding MAC addresses to the payload of a packet. For example, each pair of MAC address (17 bytes) and RSSI (4 bytes) values may be concatenated using a colon (:) as the delimiter, resulting in a total length of 23 bytes per pair, and provided as a modified payload of a packet. In some embodiments, a packet with the modified payload is provided by the UE to the connected node. In some embodiments, if there are no flow rules at the connected node that match the packet provided by the UE, the packet is forwarded to the SDN controller by a switch as a packet-in message.

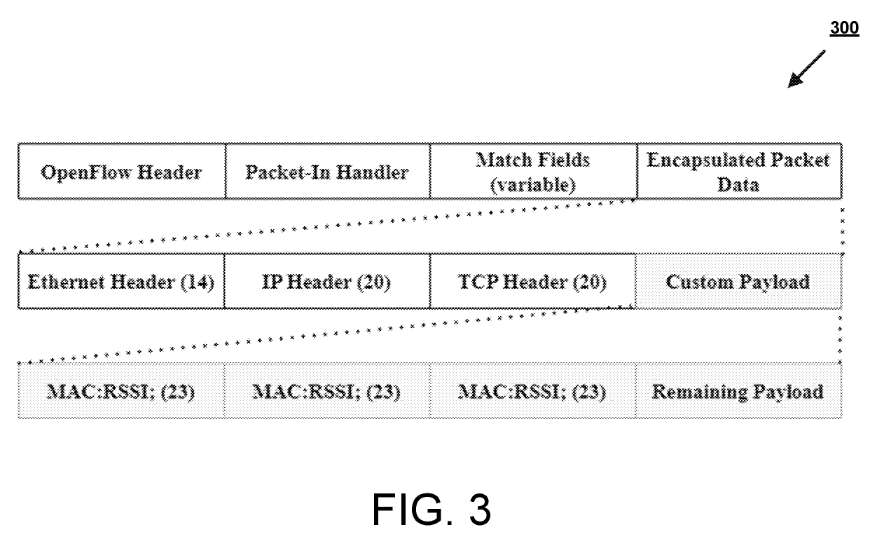

FIG. 3 is an example TCP packet format 300 in accordance with some embodiments of the present disclosure. A packet-in message may comprise a packet that comprises the TCP packet format 300. For example, a connected node may be interfaced with an SDN controller via an OpenFlow-enabled switch that maintains flow tables of MAC and Internet Protocol (IP) addresses associated with packet routes. As such, the packet-in message may be generated based on the TCP packet format 300 to conform with OF (and/or the like) specifications by appending the packet with additional headers. The additional headers may comprise fields, such as buffer ID, total length, reason for packet-in, and match structure. Upon receipt and processing of the packet-in message by the SDN controller, the SDN controller may configure a corresponding flow rule at the connected node to handle similar traffic in the future.

In some embodiments, a connected node provides a packet-in message to an SDN controller in response to a programmed hard time-out. In some embodiments, a hard time-out comprises a program or instruction used to configure a node that is connected to a UE to clear and/or remove flow rules stored and/or programmed on the node after a predetermined amount of time. In some embodiments, the absence of flow rules at the connected node causes a switch (e.g., OpenFlow-enabled) to forward a packet comprising a modified payload received from the UE to the SDN controller as a packet-in message. As such, MAC addresses of all nodes in range and corresponding RSSI levels obtained by the UE may be provided to the SDN controller by the packet-in message. Accordingly, the SDN controller may be provided with periodic updates of a UE’s position within a multi-RAT network via packet-in messages and may be able to anticipate when a handover should be triggered.

Upon receiving a packet-in message, an SDN controller may activate an appropriate packet-in handler within the SDN controller’s repository to process the packet-in message. As such, handover functionality may be incorporated into the packet-in handling operations. In some embodiments, an SDN controller records and/or monitors which node a UE is currently connected to by extracting and/or identifying an identifier, such as a data path identifier, from the packet-in message. In some embodiments, a packet-in message with a modified payload is used by an SDN controller to identify a handover and configure relevant flow rules. For example, if an SDN controller receives a packet-in message that comprises an RSSI and MAC of only a connected node, the packet-in message may indicate that there are no other nodes in range of the UE, and as such, a flow rule with IP-based matching may be configured in the connected node to replace a deleted flow rule due to hard time-out.

Otherwise, if the SDN controller receives a packet-in message that comprises a plurality of nodes (e.g., WiFi APs 106 and/or gNBs 108) and corresponding RSSI levels, the SDN controller may compare the RSSI levels to determine if a handover is about to occur or has already occurred. For example, if a RSSI level at a node that is connected to a UE is greater than RSSI levels of other nodes in range of the UE, a handover has not occurred. Thus, a flow rule with IP-based matching may be configured in the connected node to replace a deleted flow rule due to hard time-out and no flow rules may be configured at the other nodes. On the other hand, if the received packet-in message indicates that there is new node with a higher RSSI level than the connected node, the UE may have moved into the new node’s coverage area, and a handover process may be triggered. As such, the SDN controller may obtain the new node’s DPID and MAC address to configure flow rules on the new node. In addition to configuring the flow rule on the new node, the SDN controller may also configure an additional flow rule on the connected node to replace a deleted flow rule due to hard time-out. Configuration of flow rules on both the new node and the connected node may facilitate dynamic buffering of packets during handover, thereby resulting in reduced packet loss during the handover.

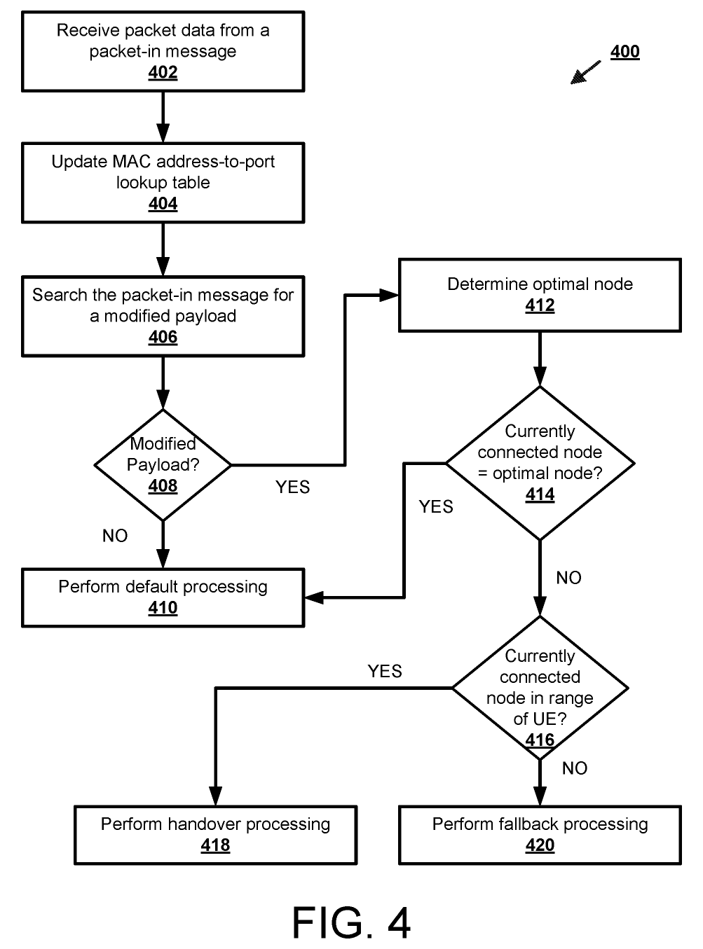

FIG. 4 depicts a flowchart of an example process 400 for processing a packet-in message in accordance with some embodiments of the present disclosure. It is noted that each block of a flowchart, and combinations of blocks in the flowchart, may be implemented by various means such as hardware, firmware, circuitry, and/or other devices associated with execution of software including one or more computer program instructions. For example, one or more of the steps/operations described in FIG. 4 may be embodied by computer program instructions, which may be stored by a non-transitory memory of an apparatus employing an embodiment of the present disclosure and executed by a processor component in an apparatus (such as, but not limited to, an SDN controller of the plurality of SDN controllers 206). For example, these computer program instructions may direct the processor component to function in a particular manner, such that the instructions stored in the computer-readable storage memory produce an article of manufacture, the execution of which implements the function specified in the flowchart block(s).

In some embodiments, the process 400 begins at step/operation 402 when one or more processors (e.g., corresponding to an SDN controller) receive and/or extracts packet data (e.g., MAC/IP headers) from a packet-in message that is forwarded from a currently connected node. For example, an SDN controller may comprise a packet-in handler that is configured to extract packet data, such as source and destination MAC addresses, source and destination IP addresses, source and destination port addresses, match fields, and/or other flow-related data, from MAC/IP headers of the packet-in message.

In some embodiments, at step/operation 404, the one or more processors update a MAC address-to-port lookup table based on a source MAC address and a corresponding input port address from the packet data. An association and/or mapping between the source MAC address and the input port may be learned from the packet-in message and consistently maintained for incoming packet-in messages within an SDN controller and stored to the MAC address-to-port lookup table. The MAC address-to-port lookup table may enable an SDN controller to efficiently determine which device with a specific MAC address is connected to which output port within a network.

In some embodiments, at step/operation 406, the one or more processors search the packet-in message for a modified payload. For example, the length of the packet-in message may be analyzed to determine the presence of a modified payload with RSSI information.

In some embodiments, at step/operation 408, the one or more processors determine whether a modified payload is present.

In some embodiments, at step/operation 410, if the one or more processors determine that a modified payload is not present, or if the packet-in message is received from a node hosting a server, default processing is performed by the one or more processors as follows:

If the destination MAC address is known at the SDN controller:

An output port is assigned using the MAC address-to port lookup table.

A flow rule is created to avoid future flooding or broadcasting as follows:

If the received packet-in message is IP based, and has source and destination IP addresses, a match object is generated based on the source and destination IP fields.

The match object is used to construct a flow rule that forwards packets to the assigned output port.

The flow rule with a hard time-out of x seconds (e.g., 5 seconds) is configured in the switch.

If the destination MAC address is unknown, the output port is set to a flooding action (e.g., send a packet corresponding to the packet-in message to all connected ports except the port from which the packet was received from). Additionally, since flooding is being used, no flow rule is configured.

In some embodiments, at step/operation 412, if the one or more processors determine that a modified payload is present, the one or more processors determine an optimal node by performing the following:

extracting the modified payload from a TCP frame of the packet-in message;

retrieving one or more RSSI values and one or more MAC addresses that correspond to the one or more RSSI values from the modified payload, wherein the one or more RSSI values and the one or more MAC addresses correspond to nodes which are in range (e.g., of a UE); and

determining the optimal node based on the one or more RSSI values, wherein the optimal node comprises a highest RSSI value relative to the one or more RSSI values (e.g., of all the nodes in range of the UE).

In some embodiments, at step/operation 414, the one or more processors determine whether the optimal node is a currently connected node of a UE.

In some embodiments, at step/operation 410, if the one or more processors determine that the currently connected node is the optimal node (e.g., the UE’s currently connected node has highest RSSI), default processing is performed. For example, no handover occurs between nodes based on a RSSI indicating that a current path between the currently connected node and the UE is still optimal. Default processing is performed by the one or more processors as follows:

The source MAC address and its input port are recorded from the packet data to the MAC address-to-port lookup table.

If the destination MAC address is known at the SDN controller:

An output port is assigned using the MAC address-to-port lookup table.

A flow rule is created to avoid future flooding or broadcasting as follows:

If the received packet is IP based, and has source and destination IP addresses, a match object is generated using source and destination IP fields.

The match object is used to generate a flow rule that forwards packets to the assigned output port.

The flow rule with a hard time-out of x seconds is configured in the switch.

If the destination MAC address is unknown, the output port is set to a flooding action (e.g., send the packet corresponding to the packet-in message to all connected ports except the port from which the packet was received from). Additionally, since flooding is being used, no flow rule is configured.

In some embodiments, at step/operation 416, the one or more processors determine whether the currently connected node is in range of the UE.

In some embodiments, at step/operation 418, if the one or more processors determine the currently connected node does not have the highest RSSI, but one of the other nodes in range has highest RSSI, and the currently connected node is in range of the UE, the one or more processors performs handover processing. That is, a handover may occur when the optimal node is not the currently connected node, indicating the UE is about to move away from the currently connected node. Handover processing may be performed by the one or more processors as follows:

Output ports are set to flood to ensure that the packet corresponding to the packet-in message is forwarded to all nodes connected to the UE until an explicit path is setup and no packets are lost during the handover.

If the received packet is IP based, and has source and destination IP addresses, a match object is generated using source and destination IP fields.

A flow rule is generated based on the match object and actions to flood the packet.

The flow rule, with a hard time-out of x seconds, is configured on the optimal node, the currently connected node, and potentially any intermediate nodes (e.g., second-best nodes) to ensure optimal packet handling and redirection through the optimal node.

Configuration of flow rules in both the optimal node (that is not the currently connected node) and the currently connected node may facilitate dynamic buffering of packets during the handover, thereby resulting in reduced packet loss during handover.

In some embodiments, at step/operation 420, if the one or more processors determine the currently connected node is not in range of the UE, but the currently connected node is sending a packet-in as a result of flooded packets, the following fallback processing may be performed by the one or more processors: Given the destination MAC address is unknown in the context of RSSI, set the output port to flood, to broadcast the packet corresponding to the packet-in message. If the received packet is IP-based, and has source and destination IP addresses, generate a match object based on the source and destination IP addresses. Configure a flow rule based on the match object and actions on the switch that the packet-in message was received from to ensure that future similar packets are efficiently handled, even if they need to be flooded.

Given the destination MAC address is unknown in the context of RSSI, set the output port to flood, to broadcast the packet corresponding to the packet-in message.

If the received packet is IP-based, and has source and destination IP addresses, generate a match object based on the source and destination IP addresses.

Configure a flow rule based on the match object and actions on the switch that the packet-in message was received from to ensure that future similar packets are efficiently handled, even if they need to be flooded.

The aforementioned steps may ensure the successful routing of packets that are received at other nodes due to flooding such that packets are not dropped and are routed even in cases of a connection drop during handover. As disclosed herewith, to ensure that RSSI levels for each UE and the nodes within range of the UE are consistently updated, an SDN controller may periodically delete all flow rules from node through the hard time-outs. The deletion forces a node that is currently connected to a UE to generate packet-in messages upon each time-out, allowing the SDN controller to maintain up-to-date topological information for each UE.

### Conclusion

It should be understood that the examples and embodiments described herein are for illustrative purposes only and that various modifications or changes in light thereof will be suggested to persons skilled in the art and are to be included within the spirit and purview of this application.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

1. A computer-implemented method comprising:
receiving, by one or more processors, a packet-in message from a connected node, wherein the packet-in message comprises a modified payload with data corresponding to one or more received signal strength indicator (RSSI) levels and one or more media access control (MAC) addresses corresponding to one or more nodes that are within range of a user equipment (UE);
determining, by the one or more processors, an optimal node based on the one or more RSSI levels, wherein the optimal node comprises a highest RSSI level relative to the one or more RSSI levels; and
in response to determining that the optimal node is different from the connected node, performing, by the one or more processors, handover processing comprising configuring a flow rule on the optimal node.

2. The computer-implemented method of claim 1, wherein the UE periodically scans for the one or more nodes and appends the one or more RSSI levels to a payload of a packet corresponding to the packet-in message.

3. The computer-implemented method of claim 1 further comprising:
updating a MAC address-to-port lookup table based on a source MAC address and an input port address from the packet-in message;
searching the packet-in message for the modified payload; and
determining the modified payload is present in the packet-in message.

4. The computer-implemented method of claim 3 further comprising, in response to determining that the optimal node comprises the connected node:
in response to determining that a destination MAC address is known:
assigning an output port based on the MAC address-to-port lookup table; and
generating a match object based on a source Internet Protocol (IP) address and a destination IP address to generate the flow rule that forwards one or more packets to the output port.

5. The computer-implemented method of claim 4 further comprising, in response to determining that the destination MAC address is unknown:
configuring the output port to a flooding action.

6. The computer-implemented method of claim 1, wherein performing the handover processing further comprises:
configuring one or more output ports to a flooding action that corresponds to forwarding the packet-in message to the one or more nodes until a path setup;
generating a match object based on a source Internet Protocol (IP) address and a destination IP address;
generating, based on the match object, the flow rule that initiates the flooding action; and
configuring the flow rule on the optimal node, the connected node, and one or more intermediate nodes.

7. The computer-implemented method of claim 1, further comprising:
determining whether the connected node is in range of the UE; and
in response to determining that the connected node is not in range of the UE, performing fallback processing comprising:
configuring an output port to a flooding action that corresponds to broadcasting a packet corresponding to the packet-in message;
generating a match object based on a source Internet Protocol (IP) address and a destination IP address; and
configuring the flow rule based on the match object and one or more actions on a switch that the packet-in message was received from.

8. The computer-implemented method of claim 1, wherein the flow rule comprises a hard time-out.

9. A system comprising
one or more processors and
one or more non-transitory computer readable media storing processor-executable instructions that, when executed by the one or more processors, cause the one or more processors to perform operations comprising:
receiving a packet-in message from a connected node, wherein the packet-in message comprises a modified payload with data corresponding to one or more received signal strength indicator (RSSI) levels and one or more media access control (MAC) addresses corresponding to one or more nodes that are within range of a user equipment (UE);
determining an optimal node based on the one or more RSSI levels, wherein the optimal node comprises a highest RSSI level relative to the one or more RSSI levels; and
in response to determining that the optimal node is different from the connected node, performing, by the one or more processors, handover processing comprising configuring a flow rule on the optimal node.

10. The system of claim 9, wherein the UE periodically scans for the one or more nodes and appends the one or more RSSI levels to a payload of a packet corresponding to the packet-in message.

11. The system of claim 9 wherein the operations further comprise:
updating a MAC address-to-port lookup table based on a source MAC address and an input port address from the packet-in message;
searching the packet-in message for the modified payload; and
determining the modified payload is present in the packet-in message.

12. The system of claim 11 wherein the operations further comprise, in response to determining that the optimal node comprises the connected node:
in response to determining that a destination MAC address is known:
assigning an output port based on the MAC address-to-port lookup table; and
generating a match object based on a source Internet Protocol (IP) address and a destination IP address to generate the flow rule that forwards one or more packets to the output port.

13. The system of claim 12 wherein the operations further comprise, in response to determining that the destination MAC address is unknown:
configuring the output port to a flooding action.

14. The system of claim 9, wherein performing the handover processing further comprises:
configuring one or more output ports to a flooding action that corresponds to forwarding the packet-in message to the one or more nodes until a path setup;
generating a match object based on a source Internet Protocol (IP) address and a destination IP address;
generating, based on the match object, the flow rule that initiates the flooding action; and
configuring the flow rule on the optimal node, the connected node, and one or more intermediate nodes.

15. The system of claim 9, wherein the operations further comprise:
determining whether the connected node is in range of the UE; and
in response to determining that the connected node is not in range of the UE, performing fallback processing comprising:
configuring an output port to a flooding action that corresponds to broadcasting a packet corresponding to the packet-in message;
generating a match object based on a source Internet Protocol (IP) address and a destination IP address; and
configuring the flow rule based on the match object and one or more actions on a switch that the packet-in message was received from.

16. The system of claim 9, wherein the flow rule comprises a hard time-out.

17. One or more non-transitory computer-readable storage media storing instructions that, when executed by one or more processors, cause the one or more processors to perform operations comprising:
receiving a packet-in message from a connected node, wherein the packet-in message comprises a modified payload with data corresponding to one or more received signal strength indicator (RSSI) levels and one or more media access control (MAC) addresses corresponding to one or more nodes that are within range of a user equipment (UE);
determining an optimal node based on the one or more RSSI levels, wherein the optimal node comprises a highest RSSI level relative to the one or more RSSI levels; and
in response to determining that the optimal node is different from the connected node, performing, by the one or more processors, handover processing comprising configuring a flow rule on the optimal node.

18. The one or more non-transitory computer-readable storage media of claim 17, wherein the UE periodically scans for the one or more nodes and appends the one or more RSSI levels to a payload of a packet corresponding to the packet-in message.

19. The one or more non-transitory computer-readable storage media of claim 17, wherein the operations further comprise:
updating a MAC address-to-port lookup table based on a source MAC address and an input port address from the packet-in message;
searching the packet-in message for the modified payload; and
determining the modified payload is present in the packet-in message.

20. The one or more non-transitory computer-readable storage media of claim 19, wherein the operations further comprise, in response to determining that the optimal node comprises the connected node:
in response to determining that a destination MAC address is known:
assigning an output port based on the MAC address-to-port lookup table; and
generating a match object based on a source Internet Protocol (IP) address and a destination IP address to generate the flow rule that forwards one or more packets to the output port.
